(19) United States
(12) Patent Application Publication
(10) Pub. No.: US 2024/0288689 A1
(43) Pub. Date: Aug. 29, 2024

(54) CONTACT LENS AND EYE TRACKING DEVICE

(71) Applicant: HTC Corporation, Taoyuan City (TW)

(72) Inventors: Chun-Yih Wu, Taoyuan City (TW); Ta-Chun Pu, Taoyuan City (TW); Yen-Liang Kuo, Taoyuan City (TW)

(73) Assignee: HTC Corporation, Taoyuan City (TW)

(21) Appl. No.: 18/173,803

(22) Filed: Feb. 24, 2023

(51) Int. Cl. G02B 27/00; G02C 7/04; G02C 11/00

(52) U.S. Cl. CPC G02B 27/0093; G02C 7/04; G02C 11/10

(57) ABSTRACT

A contact lens and an eye tracking device are provided. The contact lens includes a first type polarization structure and a second type polarization structure. The first type polarization structure is disposed in a first area of the contact lens, and the first area surrounds a center area of the contact lens. The second type polarization structure is disposed in a second area of the contact lens, and the second area surrounds the first area. The first type polarization structure and the second type polarization structure have different polarization directions.

### TECHNICAL FIELD

The disclosure relates to a contact lens and an eye tracking device, and in particular to a contact lens and an eye tracking device suitable for a virtual image display system.

### DESCRIPTION OF RELATED ART

With the advancement of image display technology, the visual experience of presenting a three-dimensional virtual image through a virtual image display effect has become a mainstream technology in recent years. In the virtual image display system, in order to provide sufficient information for the interaction between the user and the virtual image, the line of sight direction of an eye of the user becomes an important piece of information. As such, several eye tracking techniques can be proposed.

However, in order to improve the degree of immersion of the user in the virtual world, an accurate eye tracking action becomes an indispensable element. Therefore, how to effectively enhance the precision of the eye tracking action has become an important topic for persons skilled in the art.

### SUMMARY

The disclosure provides a contact lens and an eye tracking device, which can improve the precision of an eye tracking action.

The contact lens of the disclosure includes a first type polarization structure and a second type polarization structure. The first type polarization structure is disposed in a first area of the contact lens, and the first area surrounds a center area of the contact lens. The second type polarization structure is disposed in a second area of the contact lens, and the second area surrounds the first area. The second type polarization structure and the first type polarization structure have different polarization directions.

The eye tracking device of the disclosure includes a contact lens, a beam transmitter, and a beam receiver. The contact lens includes a first type polarization structure and a second type polarization structure. The first type polarization structure is disposed in a first area of the contact lens, and the first area surrounds a center area of the contact lens. The second type polarization structure is disposed in a second area of the contact lens, and the second area surrounds the first area. The second type polarization structure and the first type polarization structure have different polarization directions. The beam transmitter projects a transmission beam to the contact lens, so that the contact lens correspondingly generates a first reflection beam with a first polarization direction and a second reflection beam with a second polarization direction. The beam receiver receives the first reflection beam and the second reflection beam. The eye tracking device tracks a line of sight direction of a user according to intensities of the first reflection beam and the second reflection beam.

Based on the above, the contact lens of the disclosure is respectively configured with the first type polarization structure and the second type polarization structure having different polarization directions in the first area and the second area. When executing the eye tracking action, the contact lens may reflect the transmission beam projected to an eye of the user through the first type polarization structure and the second type polarization structure, so as to generate the reflection beams having different polarization directions. Therefore, the eye tracking device may calculate a polarization angle of the reflection beam according to the intensities of the reflection beams having different polarization directions, and calculate the line of sight direction of the eye accordingly.

### BRIEF DESCRIPTION OF THE DRAWINGS

FIG. 1 is a schematic diagram of a contact lens according to an embodiment of the disclosure.

FIG. 2 to FIG. 5 are schematic diagrams of a contact lens according to multiple different embodiments of the disclosure.

FIG. 6 is a schematic diagram of an eye tracking device according to an embodiment of the disclosure.

### DETAILED DESCRIPTION OF DISCLOSED EMBODIMENTS

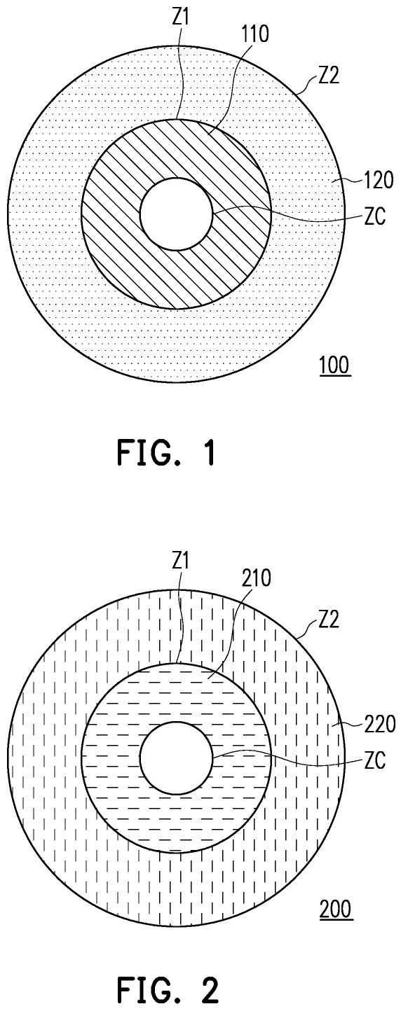

Please refer to FIG. 1. FIG. 1 is a schematic diagram of a contact lens according to an embodiment of the disclosure. A contact lens 100 includes a first type polarization structure 110 and a second type polarization structure 120. The first type polarization structure 110 is disposed in a first area Z1 of the contact lens 100. The first area Z1 of the contact lens 100 may be a ring area. The first area Z1 may be next to a center area ZC and surround the center area ZC. The second type polarization structure 120 is disposed in a second area Z2 of the contact lens 100. The second area Z2 may be a ring area. The second area Z2 may be next to the first area Z1 and surround the first area Z1.

In the embodiment, the first type polarization structure 110 and the second type polarization structure 120 have different polarization directions. For example, the first type polarization structure 110 may have a horizontal polarization direction, and the second type polarization structure may have a vertical polarization direction. Alternatively, the first type polarization structure 110 may have a vertical polarization direction, and the second type polarization structure may have a horizontal polarization direction.

The contact lens 100 of the embodiment of the disclosure may be applied in a virtual image display system. When the virtual image display system executes an eye tracking action, a transmission beam that is a collimated beam may be projected to an eye of a user through a beam transmitter. Through the contact lens 100 worn on the eye of the user, according to the first type polarization structure 110 and the second type polarization structure 120 having different polarization directions, the contact lens 100 may generate reflection beams having different polarization directions according to the reflected transmission beam. In this way, the eye tracking device of the virtual image display system may calculate a line of sight direction of the eye according to intensities of the reflection beams having different polarization directions.

Incidentally, in the embodiment of the disclosure, the first type polarization structure 110 and the second type polarization structure 120 on the contact lens 100 may be respectively constructed through polarization coatings having different polarization directions. The polarization coating may be constructed using materials well known to persons skilled in the art, and there is no special limitation.

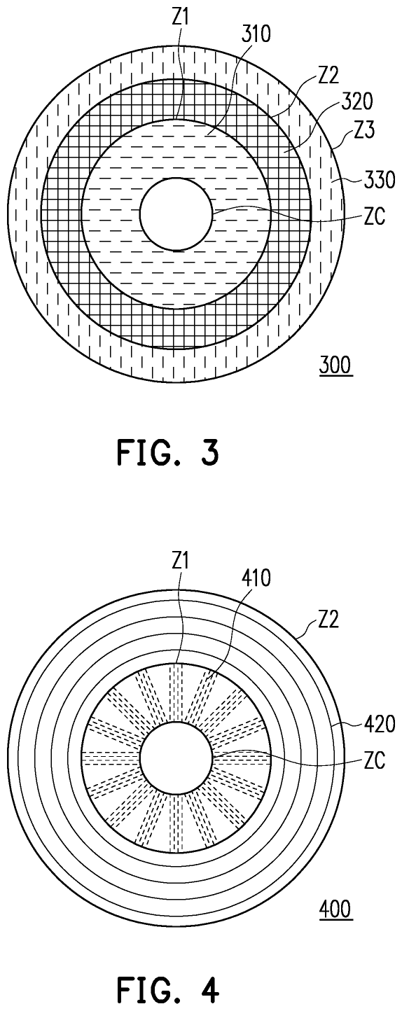

Please refer to FIG. 2 below. FIG. 2 is a schematic diagram of a contact lens according to another embodiment of the disclosure. A contact lens 200 includes a first type polarization structure 210 and a second type polarization structure 220. The first type polarization structure 210 is disposed in a first area Z1 of the contact lens 200. The second type polarization structure 220 is disposed in a second area Z2 of the contact lens 200. The first area Z1 surrounds a center area ZC of the contact lens 200, and the second area Z2 surrounds the first area Z1. The first area Z1 is between the second area Z2 and the center area ZC.

In the embodiment, the first type polarization structure 210 may have a horizontal polarization direction, and the second type polarization structure 220 may have a vertical polarization direction.

Please refer to FIG. 3 below. FIG. 3 is a schematic diagram of a contact lens according to another embodiment of the disclosure. A contact lens 300 includes a first type polarization structure 310, a second type polarization structure 320, and a third type polarization structure 330. The first type polarization structure 310 is disposed in a first area Z1 of the contact lens 300, the second type polarization structure 320 is disposed in a second area Z2 of the contact lens 300, and the third type polarization structure 330 is disposed in a third area Z3 of the contact lens 300. In the embodiment, the first area Z1 is next to a center area ZC of the contact lens 300 and is disposed surrounding the center area ZC. The third area Z3 is disposed between the first area Z1 and the second area Z2, and surrounds the first area Z1. The second area Z2 is next to the third area Z3 and is disposed surrounding the third area Z3. Specifically, the second area Z2 is located at the outermost ring of the contact lens 300, the first area Z1 is located at the innermost ring excluding the center area ZC of the contact lens 300, and the third area Z3 is located between the first area Z1 and the second area Z2.

In the embodiment, the first type polarization structure 310 may have a horizontal polarization direction, and the second type polarization structure 320 may have a vertical polarization direction. It is worth noting that the second type polarization structure 330 may have a horizontal polarization direction and a vertical polarization direction at the same time.

Similar to the foregoing embodiments, the contact lens 300 of the embodiment may reflect a received transmission beam that is a collimated beam to generate reflection beams having different polarization directions. In this way, the eye tracking device of the virtual image display system may calculate a line of sight direction of an eye according to intensities of the reflection beams having different polarization directions.

Incidentally, in the embodiment, the width of the first area Z1 may be equal to the width of the second area Z2. The width of the third area Z3 may be set by the designer according to actual requirements, and there is no fixed limitation. Of course, in other embodiments of the disclosure, the width of the first area Z1 may not be equal to the width of the second area Z2, and there is no fixed limitation.

Please refer to FIG. 4 below. FIG. 4 is a schematic diagram of a contact lens according to another embodiment of the disclosure. A contact lens 400 includes a first type polarization structure 410 and a second type polarization structure 420. The first type polarization structure 410 and the second type polarization structure 420 are respectively disposed in a first area Z1 and a second area Z2 of the contact lens 400. The first area Z1 is an inner ring area surrounding a center area ZC, and the second area Z2 is an outer ring area surrounding the first area Z1.

In the embodiment, the first type polarization structure 410 has a first polarization direction toward the center of circle of the center area ZC. The second type polarization structure 420 has a second polarization direction perpendicular to the first polarization direction. Specifically, the first polarization direction of the first type polarization structure 410 is parallel to a normal vector at any point on an outer ring of the center area ZC, and the second polarization direction of the first type polarization structure 420 is parallel to a tangent vector at any point on the outer ring of the center area ZC.

Similarly, similar to the foregoing embodiments, the contact lens 400 of the embodiment may reflect a received transmission beams that is a collimated beam to generate reflection beams having different polarization directions. In this way, the eye tracking device of the virtual image display system may calculate a line of sight direction of an eye according to intensities of the reflection beams having different polarization directions.

Please refer to FIG. 5 below. FIG. 5 is a schematic diagram of a contact lens according to another embodiment of the disclosure. A contact lens 500 includes a first type polarization structure 510, a second type polarization structure 520, and a third type polarization structure 530. The first type polarization structure 510, the second type polarization structure 520, and the third type polarization structure 530 are respectively disposed in a first area Z1, a second area Z2, and a third area Z3 of the contact lens 500. The first area Z1 is an inner ring area surrounding the center area ZC, the third area Z3 is disposed between the first area Z1 and the second area Z2, and surrounds the first area Z1, and the second area Z2 is an outer ring area surrounding the third area Z3.

In the embodiment, polarization directions of the first type polarization structure 510 and the second type polarization structure 520 are respectively the same as the polarization directions of the first type polarization structure 410 and the second type polarization structure 420 in the embodiment of FIG. 4. It is worth mentioning that in the embodiment, the third type polarization structure 530 has the first polarization direction of the first type polarization structure 510 and the second polarization direction of the second type polarization structure 520 at the same time.

The contact lens 500 of the embodiment may also reflect a received transmission beam that is a collimated beam to generate reflection beams having different polarization directions. In this way, the eye tracking device of the virtual image display system may calculate a line of sight direction of an eye according to intensities of the reflection beams having different polarization directions.

Incidentally, in the embodiment, the width of the first area Z1 may be equal to the width of the second area Z2. The width of the third area Z3 may be set by the designer according to actual requirements, and there is no fixed limitation. Of course, in other embodiments of the disclosure, the width of the first area Z1 may not be equal to the width of the second area Z2, and there is no fixed limitation.

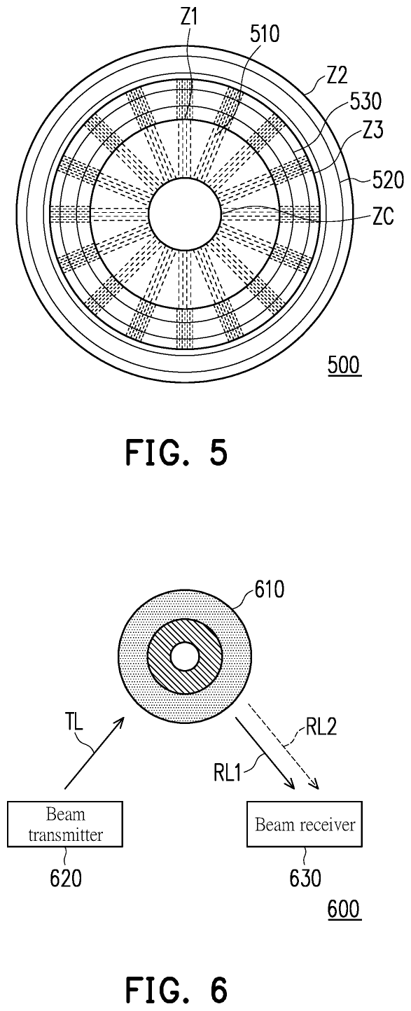

Please refer to FIG. 6 below. FIG. 6 is a schematic diagram of an eye tracking device according to an embodiment of the disclosure. An eye tracking device 600 may be applied in a virtual image display system. The eye tracking device 600 includes a contact lens 610, a beam transmitter 620, and a beam receiver 630. The contact lens 610 may be any one of the contact lenses 100 to 500 shown in FIG. 1 to FIG. 5, and relevant details have been described in detail in the foregoing embodiments and will not be repeated here. The beam transmitter 620 is configured to project a transmission beam TL to the contact lens 610 when executing an eye tracking action, so that the contact lens 610 correspondingly generates a first reflection beam RL1 having a first polarization direction and a second reflection beam RL2 having a second polarization direction. The first polarization direction is different from the second polarization direction.

The beam receiver 630 is configured to receive the first reflection beam RL1 and the second reflection beam RL2. A controller (not shown) having computing capability may be disposed in the eye tracking device 600. The controller may calculate and track a line of sight direction of a user according to intensities of the first reflection beam RL1 and the second reflection beam RL2 received by the beam receiver 630.

In detail, in the eye tracking device 600, there may be one or more beam receivers 630. The eye tracking device 600 may move the line of sight according to guidance, so that the beam receiver 630 may record the intensity and the phase of the reflection beam corresponding to the angle of view. The specifications of the contact lens 610 (configuration information related to different types of polarization structures in different areas) may be uploaded to the eye tracking device 600, so that the eye tracking device 600 may know relationship information of the polarization direction of the reflection beam and the angle of view of the eye. Then, when executing the eye tracking action, the eye tracking device 600 may obtain the polarization direction of the reflection beam according to an intensity ratio of the first reflection beam RL1 and the second reflection beam RL2 obtained by the beam receiver 630. Moreover, according to the polarization direction of the reflection beam, the eye tracking device 600 may calculate the line of sight direction of the eye of the user.

In the embodiment, the beam transmitter 620 may emit an electromagnetic wave beam in any form, such as an optical wave or an electromagnetic wave other than optical wave. The beam receiver 630 is the beam receiver 630 corresponding to the transmission beam.

In summary, the contact lens of the disclosure is respectively configured with different types of polarization structures having different polarization directions in different areas. When executing the eye tracking action, the contact lens may reflect the reflection beams having different polarization directions through different types of polarization structures. Therefore, the eye tracking device may calculate a polarization angle of reflected light according to the intensities of the reflection beams having different polarization directions to calculate the line of sight direction of the eye accordingly.

What is claimed is:

1. A contact lens, suitable for a virtual image display system, comprising:
a first type polarization structure, disposed in a first area of the contact lens, wherein the first area surrounds a center area of the contact lens; and
a second type polarization structure, disposed in a second area of the contact lens, wherein the second area surrounds the first area, and the second type polarization structure and the first type polarization structure have different polarization directions.

2. The contact lens according to claim 1, wherein the first type polarization structure has a horizontal polarization direction, and the second type polarization structure has a vertical polarization direction; or the first type polarization structure has the vertical polarization direction, and the second type polarization structure has the horizontal polarization direction.

3. The contact lens according to claim 2, further comprising:
a third area, disposed between the first area and the second area, and surrounding the first area.

4. The contact lens according to claim 3, wherein the third area has a third type polarization structure disposed in the third area, and the third type polarization structure has the horizontal polarization direction and the vertical polarization direction.

5. The contact lens according to claim 1, wherein the first type polarization structure has a first polarization direction, the second type polarization structure has a second polarization direction, and the first polarization direction is different from the second polarization direction.

6. The contact lens according to claim 5, wherein the first polarization direction is toward the center area, and the second polarization direction is perpendicular to the first polarization direction.

7. The contact lens according to claim 6, further comprising:
a third area, disposed between the first area and the second area, and surrounding the first area.

8. The contact lens according to claim 7, wherein the third area has a third type polarization structure, and the third type polarization structure has the first polarization direction and the second polarization direction.

9. The contact lens according to claim 1, wherein the first area is configured to generate a first reflection beam having a first polarization direction, the second area is configured to generate a second reflection beam having a second polarization direction, and the first polarization direction is different from the second polarization direction.

10. An eye tracking device, comprising:
a contact lens, comprising:
a first type polarization structure, disposed in a first area of the contact lens, wherein the first area surrounds a center area of the contact lens; and
a second type polarization structure, disposed in a second area of the contact lens, wherein the second area surrounds the first area, and the second type polarization structure and the first type polarization structure have different polarization directions;
a beam transmitter, for projecting a transmission beam to the contact lens, so that the contact lens correspondingly generates a first reflection beam having a first polarization direction and a second reflection beam having a second polarization direction; and
a beam receiver, for receiving the first reflection beam and the second reflection beam,
wherein the eye tracking device tracks a line of sight direction of a user according to intensities of the first reflection beam and the second reflection beam.
